(19) United States
(12) Patent Application Publication
(10) Pub. No.: US 2005/0241661 A1
(43) Pub. Date: Nov. 3, 2005

(54) Hair comb

(75) Inventors: Michael Eddinger, Rock Falls, IL (US); Raymond A. Nielsen, Sterling, IL (US); Scott A. Melton, Erie, IL (US)

Correspondence Address: GREER, BURNS & CRAIN, LTD., Suite 2500, 300 South Wacker Drive, Chicago, IL, 60606, US

(73) Assignee: WAHL CLIPPER CORP.

(21) Appl. No.: 10/833,365

(22) Filed: Apr. 28, 2004

(51) Int. Cl. B26B 19/20; A45D 24/04; A45D 24/00

(52) U.S. Cl. 132/139; 132/160

(57) ABSTRACT

A hand-held comb has a set of fine teeth and a set of coarse teeth joined by a center section. The center section preferably has an opening large enough for a finger. The fine teeth and coarse teeth extend in opposite directions away from a longitudinal axis. Some or all of the teeth can have at least one undulation, to remove loose hair and at least some of the teeth can have barbs, to remove partially cut hair strands. The teeth can have sharp edges, which also remove partially cut hair strands.

This invention relates to hair combs, and more particularly, to hair combs having undulating teeth and/or barbs on the teeth, a finger ring for ease of use, and fine and coarse comb teeth oriented in opposite directions.

### BACKGROUND OF THE INVENTION

Conventional combs are sometimes used to remove loose hair after a hair cut, but they leave some cut hair in the head. Thus, there is a need for combs that better remove more of such loose hair.

When a person's hair is cut, half cut hair strands are typically present after the hair cut, which is not preferred. There is also a need for combs that can remove half cut hair strands.

A conventional hair comb has a set of straight fine comb teeth, and a separate set of coarse comb teeth immediately adjacent the fine teeth. All of the teeth are oriented in the same direction. A user typically holds a conventional comb at the back of the device and pinches the comb, which can be tiring and even cause strain. Thus, there is a need for combs having both coarse and fine teeth that are more comfortable to hold, and reduce such strain.

Accordingly, one object of the present invention is to provide new and improved hair combs.

Still another object is to provide combs that better eliminate loose hair after a hair cut.

Yet another object of the present invention is to provide new and improved combs that can capture and remove half cut hair strands still present after a hair cut.

Another object is to provide new and improved combs that are easier to use.

### SUMMARY OF THE INVENTION

In keeping with one aspect of this invention, a generally flat, elongated hand-held comb has a first elongated end, a second elongated end and a center section. An imaginary center line passes through a longitudinal center of the comb.

The first elongated end has a plurality of fine comb teeth extending away from the center line from a first edge to a second edge of the first elongated end. The fine comb teeth are open at the second (outer) edge. The second elongated end has a plurality of coarse comb teeth extending away from the center line from a first edge to a second edge of the second elongated end. The coarse comb teeth are also open at the second (outer) edge. The second edges of the first and second elongated ends are on opposite sides of the center line of the comb. In other words, the fine and coarse teeth are oriented in opposite directions.

The center section can have an opening for a finger. In this manner, the comb can easily be twirled around the finger to change from the fine teeth to the coarse teeth and vice versa. Also, the elongated ends of the comb can be offset from the center line, which makes the comb easier to grasp.

In other aspects of the invention, at least some of the fine and/or coarse comb teeth can have at least one undulation, and at least some of the fine and/or coarse comb teeth can have barbs. The undulations help remove cut hair, and the barbs can remove and capture half cut hair strands. Moreover, edges can be provided on the comb teeth, if desired, to help remove half-cut hair strands.

### BRIEF DESCRIPTION OF THE DRAWINGS

The above mentioned and other features of this invention and the manner of obtaining them will become more apparent, and the invention itself will be best understood by reference to the following description of an embodiment of the invention taken in conjunction with the accompanying drawings, in which:

FIG. 1 is a plan view of a hair comb made according to the present invention;

FIG. 2 is a detail view of comb teeth that can be used in the present invention; and

FIGS. 3 and 4 are detail views of comb tooth tips that can be used in the present invention, taken along lines 3-3 and 4-4, respectively, in FIG. 1.

### DETAILED DESCRIPTION

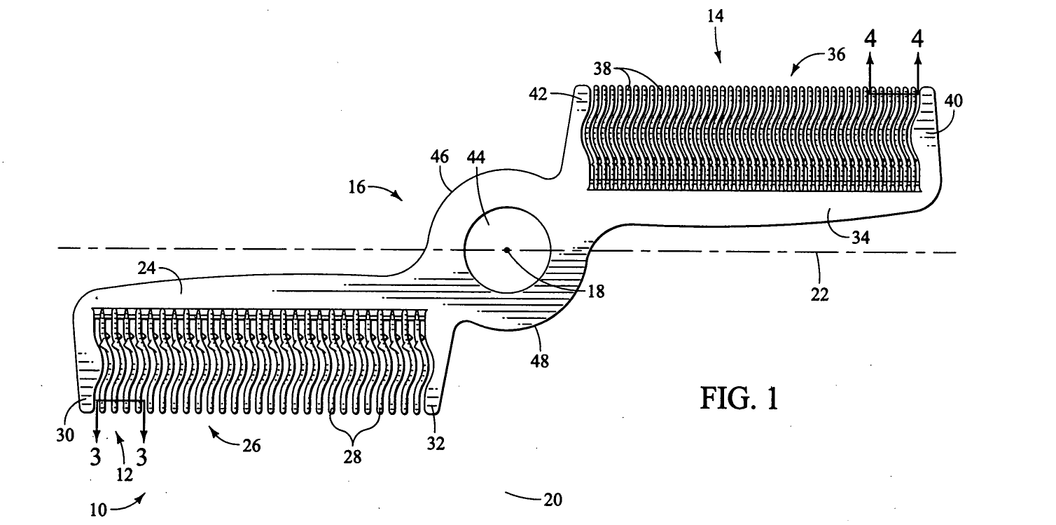

As seen in FIG. 1, a hand-held comb 10 is a generally flat, elongated device having a first end portion 12, a second end portion 14, and a center portion 16. The comb 10 is generally symmetrical about an origin 18, a vertical axis 20 and a horizontal axis 22. This axis 22 forms a longitudinal center of the comb 10.

The first end portion 12 has an inner edge 24 along the horizontal axis 22, and an outer edge 26 opposite the edge 24. A plurality of first comb teeth 28 extend away from the axis 22 from the first edge 24 to the edge 26. The edge 24 has sufficient structure to give the comb and the comb teeth strength. A relatively wide end piece 30 is provided at the outer end of the first end portion 12, and another end piece 32 is provided at the inner first end of the end portion 12. The end piece 32 is adjacent the center section 16.

The second end portion 14 has an inner end portion 34 along the horizontal axis 22, and an outer edge 36 opposite the edge portion 34. A plurality of comb teeth 38 extend away from the axis 22 from the edge portion 34 to the edge 36. Like the edge 24, the edge 34 also has sufficient structure to give the comb and the comb teeth strength. A relatively wide outer end piece 40 is provided at one end of the first portion 14, and an inner end piece 42 is provided at the other end, adjacent the center portion 16.

The first comb teeth 28 are open along the outer edge 26, and the second comb teeth 38 are open along the edge 36. The comb teeth 28 and 38 are oriented in opposite directions, i.e., the second edge 26 and the second edge 36 are on opposite sides of the axis 22.

The center portion 16 includes an opening 44 about the origin 18, and outer edges 46, 48. The edge 46 extends generally from the inner edge 24 to the inner edge portion 42, and the edge 48 extends generally from the edge portion 34 to the end piece 32. The opening 44 is large enough to accommodate a finger. With this feature, a user can easily rotate the comb around the index finger, without using another hand.

When an index finger is placed through the opening 44, the comb 10 can easily be grasped on either the first end portion 12 or the second end portion 14. To this end, the first edges 24 and 34 can be located on opposite sides of the axis 22, spaced a predetermined distance from the axis 22.

The first and second comb teeth can have different sizes and densities, similar to conventional combs. For example, the first comb teeth 28 can be relatively thick, with relatively large spaces between adjacent teeth, to accommodate coarse combing. The teeth 38 can be smaller and more dense, with less space between adjacent teeth, for fine combing.

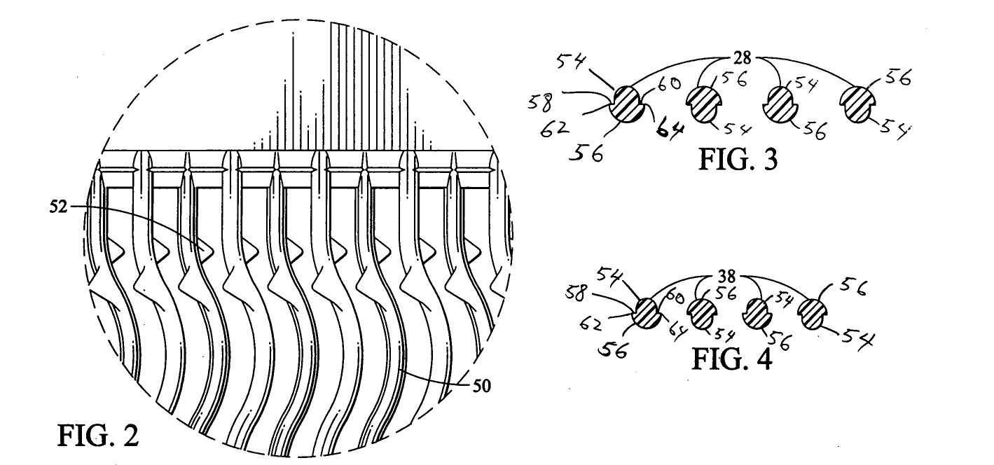

The comb teeth 28 and/or 38 could be straight, but preferably the teeth 28 and/or 38 have the curved shape shown in detail in FIG. 2. While various shapes are contemplated, FIG. 2 shows a configuration in which the teeth have a single undulation 50. The undulation helps eliminate loose hair that is still present after a hair cut. It is contemplated that the comb can feature undulating teeth without having other features of the invention. It is also contemplated that only one set of comb teeth could be undulated.

Any or all of the comb teeth 28 and/or 38 can also include a plurality of barbs 52 on some or all of the comb teeth. The barbs 52 are small plastic protrusions located preferably near the fixed or closed ends of the comb teeth. The barbs can capture half cut hair strands still present after a hair cut, by pinching loose or nicked hair between the barbs, causing the hair to be removed from the user's head.

The comb teeth can be round, if desired, but they preferably have a shape such as the shape shown in FIGS. 3 and 4. A first half 54 has a smaller diameter than a second half 56, creating ledges 58 and 60. Somewhat sharp edges 62 and 64 produced by this design helps strip cut and partially cut hair from the head. This shape can be easily made by making the teeth in one mold cavity (or mold half) smaller than the teeth in the other mold half. Also, the small halves can alternate with the large halves, as seen in FIGS. 3 and 4.

The comb 10 can be easily molded in one piece using conventional molding techniques. In use, the comb can be conveniently controlled with one hand, switching between the coarse teeth and fine teeth. The ring and offset of the comb ends from the axis 22 provide a more ergonomically correct and comfortable grip in comparison with traditional combs. The undulating comb tooth design helps eliminate loose hair, and the barbs capture loose or nicked hair. The sharp comb teeth edges also help strip nicked hair from the head.

While the principles of the invention have been described above in connection with specific apparatus and applications, it is to be understood that this description is made only by way of example and not as a limitation on the scope of the invention.

1. A generally flat, elongated hand-held comb comprising:
a first elongated end, a second elongated end and a center section, a center line passing through a longitudinal center of the comb,
said first elongated end having a plurality of first comb teeth extending away from the center line from a first edge to a second edge of said first elongated end,
said first comb teeth being open at said second edge of said first comb teeth,
said second elongated end having a plurality of second comb teeth extending away from the center line from a first edge to a second edge of said second elongated end,
said second comb teeth being open at said second edge of said second comb teeth,
said second edges of said first and second elongated ends being on opposite sides of the center line of the comb.

2. The comb of claim 1 wherein said first edges of said first and second elongated ends are on opposite sides of the center line, a predetermined distance from the center line.

3. The comb of claim 1 wherein the first comb teeth have a density and size which are different from the density and size of the second comb teeth.

4. The comb of claim 1 wherein said center section includes an opening large enough to accommodate a finger.

5. The comb of claim 1 wherein at least some of said comb teeth have at least one undulation.

6. The comb of claim 1 comprising barbs on at least some of said teeth.

7. The comb of claim 1 wherein a first half of said comb teeth have a first diameter, and a second half of said comb teeth have a second diameter, said second diameter being smaller than said first diameter.

8. A generally flat, elongated hand-held comb comprising:
a plurality of comb teeth extending away from the first edge to a second edge, the comb teeth being secured at the first edge, and open at the second edge,
said comb teeth having at least one undulation.

9. The comb of claim 8 comprising barbs on at least some of said teeth.

10. The comb of claim 8 wherein a first half of said comb teeth have a first diameter, and a second half of said comb teeth have a second diameter, said second diameter being smaller than said first diameter.
